(19) United States
(12) Patent Application Publication
(10) Pub. No.: US 2004/0259001 A1
(43) Pub. Date: Dec. 23, 2004

(54) Method of making an electrochemical cell

(76) Inventors: Gerard Francis McLean, West Vancouver (CA); Colleen Legzdins, West Vancouver (CA); Jianfei Yu, Burnaby (CA); Martin Perry, Sunnyvale, CA (US)

Correspondence Address: BUSKOP LAW GROUP, P.C., 1717 ST. JAMES PLACE, SUITE 500, HOUSTON, TX, 77056, US

(21) Appl. No.: 10/780,962

(22) Filed: Feb. 18, 2004

Related U.S. Application Data
(60) Provisional application No. 60/479,786, filed on Jun. 19, 2003.

(51) Int. Cl. H01M 10/04; H01M 10/40

(52) U.S. Cl. 429/314; 29/623.1; 429/303

(57) ABSTRACT

The invention relates to a method for making an electrochemical cell by forming a curable PFSI electrolyte by mixing a perfluro sulfonate ionomer (PFSI) with a monomer and a cross linking agent having at least two vinyl functionalities in order to form a mixture, and then removing the solvent of the PFSI by distillation to obtain a curable PFSI electrolyte, disposing the curable PFSI electrolyte on a first electrode and a second electrode forming a precursor, and treating the precursor to cure at least a portion of the curable PFSI electrolyte forming a cured electrolyte composition, and, further, the invention relates to an electrochemical cell made by the method and fuel cell made by the method.

The present application claims priority to co-pending U.S. Provisional Patent Application Ser. No. 60/479,786 filed on Jun. 19, 2003.

### FIELD

The present invention relates to an electrochemical cell made of two electrodes and a curable PFSI electrolyte and the method for forming such an electrochemical cell and a fuel cell.

### BACKGROUND

Polymer electrolyte membranes are useful in electrochemical devices such as batteries and fuel cells since they function as an electrolyte and also as a reactant separator. Typical membranes of this type are fabricated as thin films and then incorporated into cells and systems of various configurations.

Perflourinated hydrocarbon sulfonate ionomers (hereafter termed PFSI) such as Nafion™ by Dupont or analogous Dow perflourinated membranes are presently used as polymer electrolyte membranes for fuel cells. Prior art membranes, however, possess severe limitations that, in addition to their cost, detract from their utility in new and advanced fuel cell designs. A need has existed for a new design which is more durable and versatile.

PFSI is a costly material, but is difficult to replace due to its combined electrochemical performance and mechanical toughness. Other membranes possess compromising properties, such as sulfonated polystyrenes, degrade more rapidly than PFSI. Sulfonated polyaromatics often adversely swell in water and form poor interfaces with catalyst layers. PBI/phosphoric acid membranes do not operate below 120 degrees Celsius. It is hard to find a low cost alternative to PFSI because of the difficulties in finding suitable materials, synthetic methods, and the limited choice in base materials.

While PFSI is so far the membrane material of choice, it is by no means ideal. PFSI membranes soften only at temperatures less than 300 degrees Celsius. Sulfonated polyaromatics also possess very high softening temperatures and simultaneously degrade. Solid polymer electrolytes inherently possess very high softening temperatures by virtue of their high concentration of ions. Thus, processing membrane films to produce assemblies of membranes and catalyzed electrodes is restricted to high pressure, high temperature compression techniques. This is not a satisfactory situation.

Due to the lack of alternative materials and the high softening temperatures of ionic polymers, it is hard to solve this problem. This results in an overall limitation of the ways in which the electrochemical device into which the membrane is used can be manufactured. This also places constraints on material selection for the other components of the electrochemical device. The materials must now be subject to the very high temperatures and pressures required to form electrode to electrolyte interfaces. As new applications for electrochemical devices emerge, and particularly as the scale of the devices is reduced, the limitations posed by the electrolyte properties puts severe constraints on the feasibility of new designs.

Delaminating the membrane from the catalyst layer is a known mechanism of degradation of membrane-electrode assemblies. Delaminating is due to poor chemical or physical bonding. It is hard to match the chemical nature of the membrane with the catalyst layer or to form a chemical bond between the membrane and the catalyst layer. This failure mechanism is therefore a direct consequence of the manufacturing constraints imposed by the mechanical properties of the membrane material.

A need exists within the design of electrochemical cells for polymer electrolyte membranes having different properties than the PFSI like materials. Materials are needed that have similar electrochemical properties, but have different mechanical properties. Specifically, materials that become soft and pliable at lower temperatures and can be brought into intimate contact with catalyzed electrodes of arbitrary three dimensional shape without the use of high temperature compression methods are needed.

### SUMMARY

The invention relates to a method for making an electrochemical cell by first forming a curable PFSI electrolyte. The PFSI electrolyte is formed by mixing a perfluro sulfonate ionomer (PFSI) with a monomer and a cross linking agent with at least two vinyl functionalities. Next, the method entails removing the solvent of the PFSI by distillation to obtain a curable PFSI electrolyte. The curable PFSI electrolyte is disposed on a first electrode and a second electrode forming a precursor. The precursor is finally treated in order to cure at least a portion of the curable PFSI electrolyte forming a cured electrolyte composition.

The invention also relates to an electrochemical cell made by the method and a fuel cell made by the method.

### BRIEF DESCRIPTION OF THE DRAWINGS

The present invention will be explained in greater detail with reference to the appended figures, in which:

FIG. 1 depicts an exploded perspective view of a precursor.

FIG. 2 depicts a cross sectional view of a fuel cell.

FIG. 3 depicts a side view of another embodiment.

FIG. 4 depicts a cross sectional view of an assembled electrochemical cell into which curable PFSI electrolyte is being injected.

FIG. 5 depicts a cross sectional view of another embodiment of the invention wherein the curable PFSI electrolyte is shown in a channel formed in a porous substrate.

FIG. 6 depicts a cross sectional view of a multiple channel electrochemical cell into that a curable PFSI electrolyte is being injected.

FIG. 7 depicts a perspective view of a multiple channel electrochemical cell into which a curable PFSI electrolyte is disposed.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

The invention relates to a method for making an electrochemical cell by first forming a curable PFSI electrolyte. This electrolyte is formed by mixing a perfluro sulfonate ionomer (PFSI) with a monomer and a cross linking agent having at least two vinyl functionalities forming a mixture and, then removing the solvent of the PFSI by distillation to obtain a curable PFSI electrolyte.

The method for making an electrochemical cell continues by disposing the curable PFSI electrolyte on a first electrode and a second electrode forming a precursor and, finally, treating the precursor to cure at least a portion of the curable PFSI electrolyte forming a cured electrolyte composition.

Once cured, the cured electrolyte composition can be in whole or in part, a gel, a solid, or a liquid with a higher viscosity than the curable PFSI electrolyte.

The method described above can optionally be modified with the addition of an initiator into the mixture prior to forming the precursor. The addition of the initiator, such as benzyl ketals, acetophenomes, and zanthones and the like enables the precursor to be treated or cured using either photo-curing, thermal curing or combinations of these techniques. Alternatively without the initiator, the precursor can be cured with electron bombardment.

As an option, it is contemplated that a solvent could be added to the mixture to lower the cost of manufacture or change the properties of the PFSI. Also as an option, an elastisizing agent could be added to the mixture. These optional ingredients could each be added in weight percents ranging from 0 to 30 wt % of the total weight of the mixture.

In the most preferred embodiment, it is contemplated that the precursor is formed by disposing the curable PFSI electrolyte on the first electrode using a flat blade thereby forming a deposited electrolyte layer, and then disposing the second electrode on the deposited electrolyte layer.

Optionally, the method could involve the step of inserting at least one spacer between the first and second electrodes to form a cavity which can receive the curable PFSI electrolyte.

Further, the curable PFSI electrolyte can be disposed in the cavity by any number of methods. Such methods include pouring the curable PFSI electrolyte into the cavity, pumping the curable PFSI electrolyte into the cavity, injecting the curable PFSI electrolyte into the cavity, and combinations of these techniques.

The invention also contemplates that at least one, but possibly a plurality of channels can be formed in a porous substrate. Each channel would have a first channel wall and a second channel wall. The first electrode would then be formed in the first channel wall and the second channel would be formed in the second channel wall. Curable PFSI electrolyte would then be disposed or placed or injected, or poured, or pressure applied, into each channel so that the electrolyte is in communication with both the first channel wall and the second channel wall.

Once the electrolyte is inserted in the channel, the procurer is formed which can then be treated curing the curable PFSI electrolyte so that at least a portion of it is a gel, a solid, or a liquid with a higher viscosity than the curable PFSI electrolyte.

For the plurality of channels embodiment, it is contemplated that as an option, an initiator can be added to the mixture prior to forming the precursor so that the precursor can be cured with photo-curing, thermal curing or a combinations of these techniques. Without the initiator, the procurer is formed by electron bombardment.

In this embodiment, the solvent or an elasticizing agent could be added to the mixture.

The precursor is formed by disposing the curable PFSI electrolyte into the channel by impregnating the curable PFSI electrolyte into the channel using a flat blade, pouring the curable PFSI electrolyte into the channel, pumping the curable PFSI electrolyte into the channel, injecting the curable PFSI electrolyte into the channel, or by a combination of these.

To clarify the plurality of channels embodiment of the invention, it should be understood that the method would further include the steps of forming in the porous substrate a plurality of channels, wherein each channel comprises a primary channel wall and a secondary channel wall, and then forming in each channel of the plurality of channels, a primary electrode in the primary channel wall and a secondary electrode in the secondary channel wall. Next, curable PFSI electrolyte would be disposed or flowed into or pressure applied, or other inserted into each channel such that the curable PFSI electrolyte is in communication, preferably touching, both the primary channel wall and the secondary channel walls for each channel.

For the multiple channel embodiment, the method contemplates that the precursor would be cured so that the cured electrolyte composition comprises a gel, a solid, or a liquid with a higher viscosity than the curable PFSI electrolyte.

This version of the method also contemplates as an option adding an initiator to the mixture, forming the precursor and then treating the precursor with a procedure, such as photo-curing, thermal curing, or a combination of these procedures. Without the initiator, the curable PFSI electrolyte could be cured with electron bombardment.

Optionally, as with the other methods, this version of the method contemplates adding a solvent to the mixture or adding an elastising agent to the mixture.

For this versions of the method the precursor is preferably formed by disposing the curable PFSI electrolyte into the channels by impregnating the curable PFSI electrolyte into the channels using a flat blade, pouring the curable PFSI electrolyte into the channels, pumping the curable PFSI electrolyte into the channels, injecting the curable PFSI electrolyte into the channels, or suing a combination of these techniques.

Additionally, this method can have the steps of attaching a base to the porous substrate, wherein the base comprises at least one distribution plenum; at least one master port adapted for receiving the curable PFSI electrolyte; and at least one fluid port for each of the plurality of channels which is adapted for transporting curable PFSI electrolyte from the distribution plenum to each channel. With the distribution plenum step, the curable PFSI electrolyte is inserted into the distribution plenum through the master port (or ports); and the curable PFSI electrolyte flows through the distribution plenum and out the fluid port or plurality of fluid ports, into each of the channels. It is contemplated that more than one distribution plenum can be used in the invention.

The curable PFSI electrolyte can be inserted in the distribution port by using a technique such as injection insertion, pressure application, pouring, vacuum pulling, centrifugal forcing, or a combination of these.

The method will be better understood with reference to the Figures for the fuel cell and the electrochemical cell.

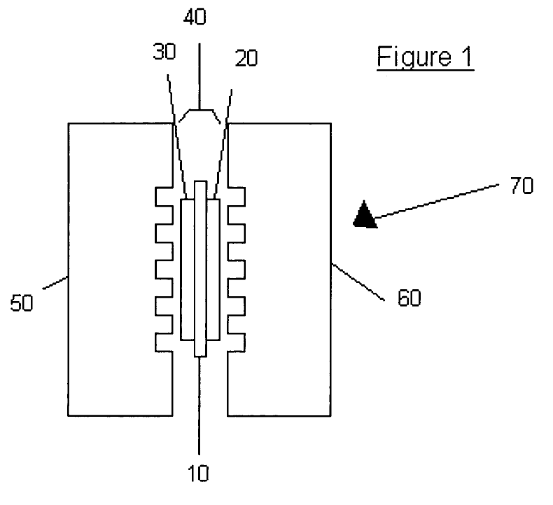

The electrochemical cell result of the method invention is shown in FIG. 1.

FIG. 1 shows an electrochemical cell having a first electrode (50), a second electrode (60), and the curable PFSI electrolyte (40) located between the first and second electrodes.

In this perspective view, the electrochemical cell includes two spacers. The first spacer (30) is shown connected to the first electrode (50) on one end and the second electrode (60) on the other end. The second spacer (20) is shown connected to the first electrode (50) on one end and the second electrode (60) on the other end. The curable electrolyte composition is disposed between the first (30) and second (20) spacers.

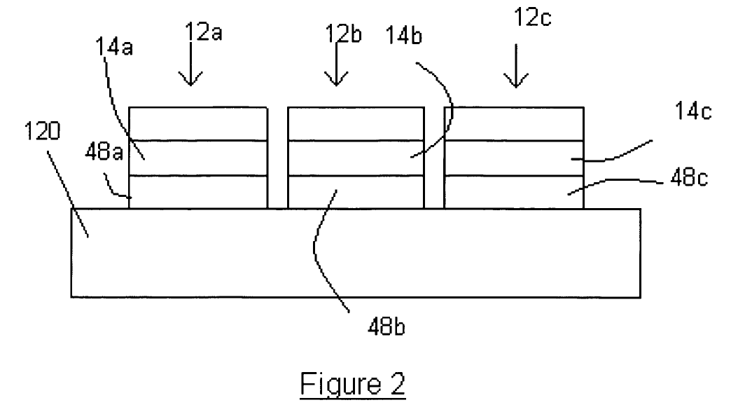

FIG. 2 shows an alternative embodiment of the fuel cell in which multiple planar fuel cells are simultaneously formed on a single substrate. In this fuel cell, multiple electrodes are shown. A planar substrate (120) is shown over which multiple first electrodes are disposed (12a, 12b, and 12c). Smooth deposited electrolyte layers (48a, 48b, and 48c) can be deposited over the first electrodes using a blade (not shown), or alternatively spin coating, spraying or ink jet printing. Multiple second electrodes (14a, 14b, and 14c) are disposed over the multiple first electrodes, one over each electrode. It is possible that one second electrode could be disposed over all of the first electrodes and still provide a usable structure within the scope of the invention.

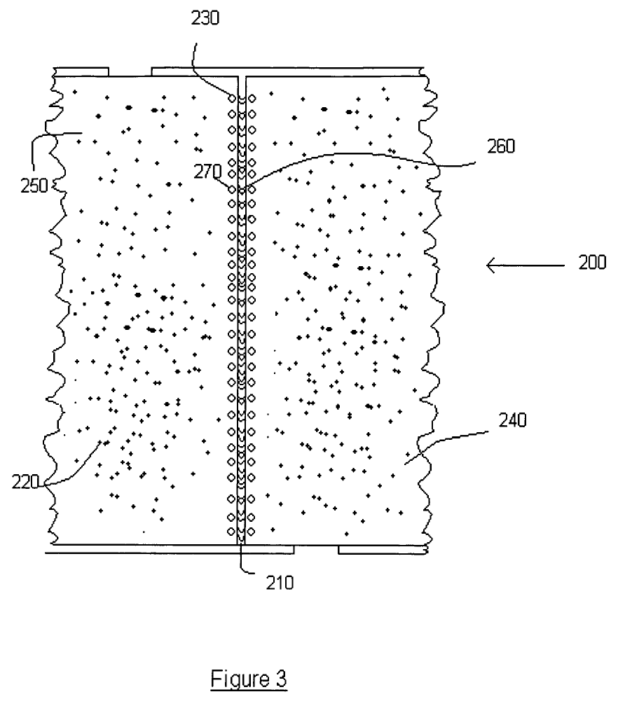

FIG. 3 shows an embodiment of an electrochemical cell with a porous substrate (220) and channel (210) located in the porous substrate (220) which can be a porous media. The channel (210) has a first channel wall (20) and second channel wall (260). The first electrode (250) is located in the first channel wall (230) and is the cathode. The second electrode (244) is located in the second channel wall (260) and forms the anode. The curable PFSI electrolyte is located in the channel (210). A catalyst (20) can be disposed on first channel wall (230) and the catalyst can be a platinum catalyst, another noble metal or transition metal catalyst or catalyst which is an alloy of noble metals or transition metals. The catalyst can be disposed on both channel walls.

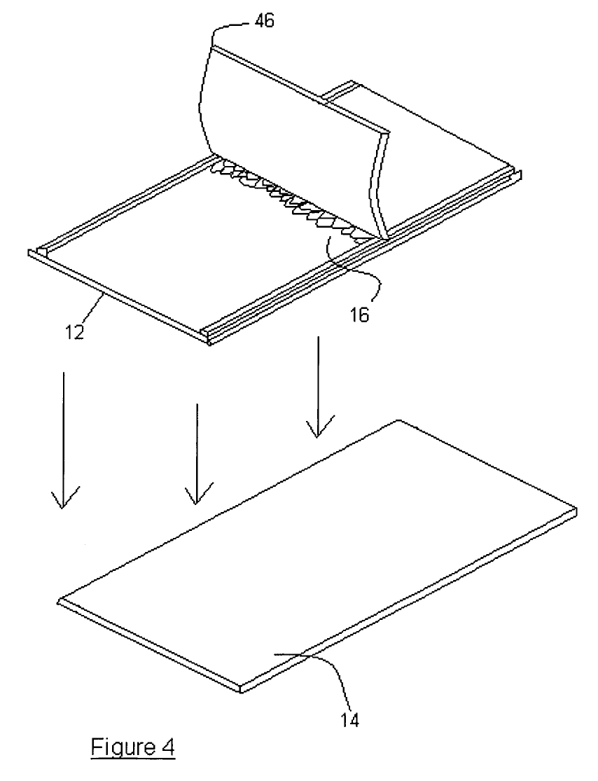

FIG. 4 illustrates another embodiment where a flat blade (46) is used to form a smooth deposited electrolyte layer (16). When the second electrode (14) is placed over the layer (16), a precursor is formed.

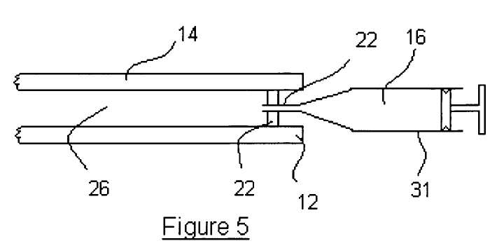

FIG. 5 shows an embodiment wherein the electrochemical cell construction has a spacer (22) with an injection port (24) located between the first and second electrodes (12) and (14). The spacer (22) forms a cavity (26) wherein the curable PFSI electrolyte (16) can be injected, disposed or otherwise inserted. A usable injector (31) is shown in this Figure.

The curable PFSI electrolyte is made of a perflourinated sultanate isomer, a monomer and a cross linking agent. In a preferred embodiment, the monomer is a vinyl phosphoric acid and the cross-linking agent is a divinyl monomer.

The curable PFSI electrolyte can further include a solvent, such as water, or a di-methyl acetamide. The curable PFSI electrolyte can also optionally contain a photo-initiator or an elastising agent, such as acrylonitirle.

The substrate used in the invention can be a carbon filled epoxy, a composite, such as graphite composite, a carbon filled polymer, a magnelli phase titanium oxide, or combinations of these, or other similar materials. The structure can be laminate or a pure structure.

Alternatively, the substrate can be foam, a monolith of porous material, an aero gel, a mat, a felt, paper, mesh, laminates thereof, composites thereof, or combinations thereof.

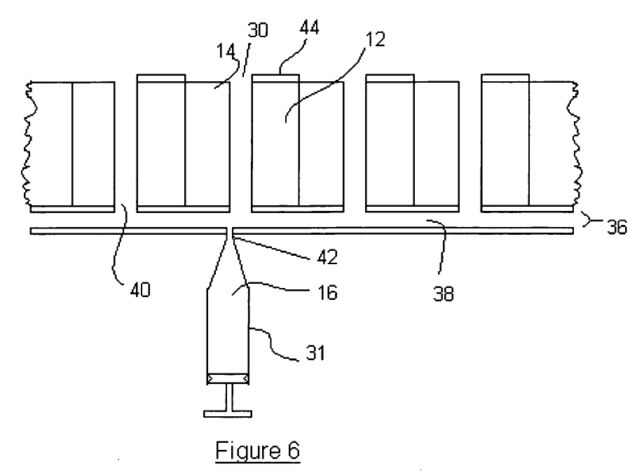

FIG. 6 shows that the electrochemical cell can include a base (36) with at least one distribution plenum (38), at least one fluid port (40) in fluid communication with the channel (30), and at least one master port (42). The distribution plenum (38) is used to transport the curable PFSI electrolyte (16). The master port (42) is used to receive curable PFSI electrolyte (16) into the base (36), such as from an injector (31). As an option, a cap (44) can be added to the electrochemical cell. The cap (44) is located over the first electrode (12) to seal the electrode region.

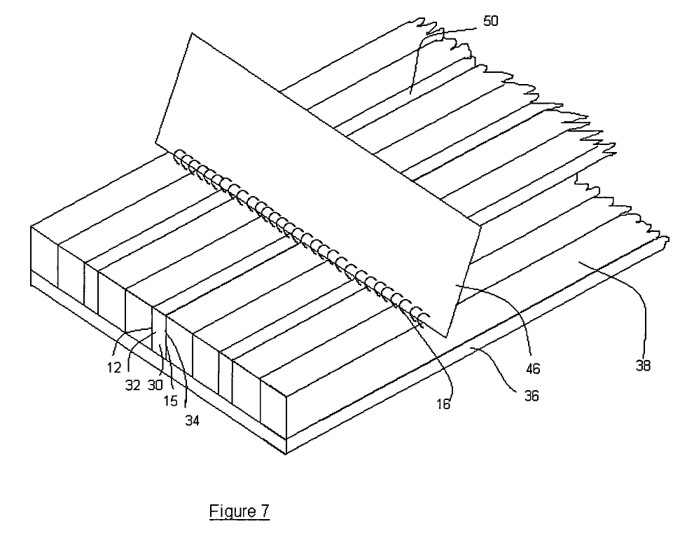

FIG. 7 shows the step of the method wherein once the curable PFSI electrolyte is formed, the solution is placed on the first and second electrodes forming a precursor (50). The curable PFSI electrolyte is shown deposited on the first electrode using a flat blade (46) forming a deposited electrolyte layer. As an option, the second electrode can then be deposited onto the deposited electrolyte layer to form the precursor. The base (36) is shown with curable PFSI electrolyte (16) disposed into channel (21). First and second electrodes (12) and (14) disposed in the channel walls (32) and (34) respectively.

The curable PFSI electrolyte can further include a solvent, such as water, or a di-methyl acetamide or combinations thereof. The curable PFSI electrolyte can also optionally contain a photo-initiator such as benzyl ketals, acetophenomes, and zanthones and the like or an elastising agent, such as acrylonitirle.

While this invention has been described with emphasis on the preferred embodiments, it should be understood that within the scope of the appended claims, the invention might be practiced other than as specifically described herein.

What is claimed is:

1. A method for making an electrochemical cell, comprising the steps:
a. forming a curable PFSI electrolyte comprising the steps of:
i. mixing a perfluro sulfonate ionomer (PFSI) with a monomer and a cross linking agent having at least two vinyl functionalities forming a mixture;
ii. removing the solvent of the PFSI by distillation to obtain a curable PFSI electrolyte;
b. disposing the curable PFSI electrolyte on a first electrode and a second electrode forming a precursor; and
c. treating the precursor to cure at least a portion of the curable PFSI electrolyte forming a cured electrolyte composition.

2. The method of claim 1, wherein the cured electrolyte composition comprises a gel.

3. The method of claim 1, wherein the cured electrolyte composition comprises a solid.

4. The method of claim 1, wherein the cured electrolyte composition comprises a liquid with viscosity higher than the curable PFSI electrolyte.

5. The method of claim 1, further comprising the step of adding an initiator to the mixture and then forming the precursor and treating the precursor with a procedure selected from the group consisting of photo-curing and thermal curing and combinations thereof.

6. The method of claim 1, wherein the treating of the precursor is performed with electron bombardment.

7. The method of claim 1, further comprising the step of adding solvent to the mixture.

8. The method of claim 1, further comprising the step of adding an elastising agent to the mixture.

9. The method of claim 1, further comprising the step of inserting at least one spacer between the first and second electrodes forming a cavity adapted to receive the curable PFSI electrolyte.

10. The method of claim 9, wherein the curable PFSI electrolyte is disposed in the cavity by a method selected from the group consisting of pouring the curable PFSI electrolyte into the cavity, pumping the curable PFSI electrolyte into the cavity, injecting the curable PFSI electrolyte into the cavity, and combinations thereof.

11. The method of claim 1, further comprising the steps:
a. forming a channel in a porous substrate wherein the channel comprises a first channel wall and a second channel wall;
b. forming the first electrode in the first channel wall;
c. forming the second electrode in the second channel wall; and
d. disposing the curable PFSI electrolyte in the channel in communication with the first and second channel walls.

12. The method of claim 11, wherein the cured electrolyte composition comprises a gel.

13. The method of claim 11, wherein the cured electrolyte composition comprises a solid.

14. The method of claim 11, wherein the cured electrolyte composition comprises a liquid with a higher viscosity than the curable PFSI electrolyte.

15. The method of claim 11, further comprising the step of adding an initiator to the mixture, forming the precursor and treating the precursor with a procedure selected from the group consisting of photo-curing, thermal curing and combinations thereof.

16. The method of claim 11, wherein the treating of the precursor is performed with electron bombardment.

17. The method of claim 11, further comprising the step of adding solvent to the mixture.

18. The method of claim 11, further comprising the step of adding an elastising agent to the mixture.

19. The method of claim 11, wherein the precursor is formed by disposing the curable PFSI electrolyte into the channel by impregnating the curable PFSI electrolyte into the channel using a flat blade, pouring the curable PFSI electrolyte into the channel, pumping the curable PFSI electrolyte into the channel, injecting the curable PFSI electrolyte into the channel, or combinations thereof.

20. The method of claim 11, further comprising the steps of:
a. forming in the porous substrate a plurality of channels, wherein each channel comprises a primary channel wall and a secondary channel wall;
b. forming in each channel of the plurality of channels, a primary electrode in the primary channel wall and a secondary electrode in the secondary channel wall; and
c. disposing curable PFSI electrolyte in each channel wherein the curable PFSI electrolyte is in communication with the primary channel wall and the secondary channel wall.

21. The method of claim 20, wherein the cured electrolyte composition comprises a gel.

22. The method of claim 20, wherein the cured electrolyte composition comprises a solid.

23. The method of claim 20, wherein the cured electrolyte composition comprises a liquid with a higher viscosity than the curable PFSI electrolyte.

24. The method of claim 20, further comprising the step of adding an initiator to the mixture, forming the precursor and treating the precursor by photo-curing, thermal curing, or combinations thereof.

25. The method of claim 20, wherein the treating of the precursor with electron bombardment.

26. The method of claim 20, further comprising the step of adding solvent to the mixture.

27. The method of claim 20, further comprising the step of adding an elastising agent to the mixture.

28. The method of claim 20, wherein the precursor is formed by disposing the curable PFSI electrolyte into the channels by a method selected from the group: impregnating the curable PFSI electrolyte into the channels using a flat blade, pouring the curable PFSI electrolyte into the channels, pumping the curable PFSI electrolyte into the channels, and injecting the curable PFSI electrolyte into the channels, and combinations thereof.

29. The method of claim 20, further comprising the step of:
a. attaching a base to the porous substrate, wherein the base comprises
i. at least one distribution plenum;
ii. at least one master port adapted for receiving the curable PFSI electrolyte; and
iii. at least one fluid port for each of the plurality of channels adapted for transporting curable PFSI electrolyte from the distribution plenum to each channel;
b. inserting the curable PFSI electrolyte into the at least one distribution plenum through the at least one master port; and
c. flowing the curable PFSI electrolyte through the at least one distribution plenum and out the at least one fluid port into each of the channels.

30. The method of claim 29, wherein the inserting of the curable PFSI electrolyte comprises using a technique selected from the group consisting of injection insertion, pressure application, pouring, vacuum pulling, centrifugal forcing, and combinations thereof.
